(19) United States
(12) Patent Application Publication
(10) Pub. No.: US 2006/0202618 A1
(43) Pub. Date: Sep. 14, 2006

(54) Wearable electronic device, method for manufacturing portable device, and portable device

(75) Inventors: Junichiro Ishii, Matsumoto-shi (JP); Shunichi Arai, Matsumoto-shi (JP); Kazutoshi Takahashi, Shiojiri-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/366,393

(22) Filed: Mar. 3, 2006

(30) Foreign Application Priority Data
Mar. 4, 2005 (JP) 2005-060215
Aug. 19, 2005 (JP) 2005-238350
Jan. 27, 2006 (JO) 2006-019555

(51) Int. Cl. A01K 7/00

(52) U.S. Cl. 313/513

(57) ABSTRACT

The device has a frame body (12) that has a substantial C-shape in cross section and is mounted on the body of a user, a strip-shaped display panel (22) disposed along the peripheral surface of the frame body (12), and a driver IC (15) for driving the display panel (22), wherein the display panel (22) and the driver IC are provided to different flexible substrates (21A, 21B), and the flexible substrates (21A, 21B) are disposed along the peripheral surface of the frame body (12) without being superposed on each other.

### FIELD OF THE INVENTION

The present invention relates to a wearable electronic device that is mounted on the wrist or the like of a user that is configured to be capable of displaying various information, to a method for manufacturing a portable device, and to a portable device; and the present invention particularly relates to a wrist-mounted portable device, or to a technique for manufacturing a device that is suitable as a portable display device.

### BACKGROUND OF THE INVENTION

Commonly known prior-art examples of electronic devices that are mounted on the wrist or the like of a user that have a display unit for displaying various types of information include wristwatches, diver's computers, and other such wrist-mounted portable devices (electronic devices). Most wrist-mounted portable devices include a main body having a display unit, and a band connected to the main body. The band is made of metal, leather, or the like, and is configured to hold the main body to the wrist.

Other concepts have been proposed for wristband-type (bracelet-style) wristwatches that have a case structure that curves around the wrist, wherein the main body and the band are integrated (for example, refer to Nonpatent Literature 1, Patent Literature 1, and Patent Literature 2). This type of structure allows for a design that is largely different from conventional wristwatches having a main body and a band, and such a structure is revolutionary in assuring an extremely large display area because there are no restrictions on the dimensions of the main body as in conventional practice.
[Nonpatent Literature 1] Seiko Watch Corporation “Innovation of Display Technology in Wristwatches, Development of Future Watches With Applied Electronic Ink Technology” (online) March 2005, Internet (accessed Jun. 24, 2005)
<URL: http://www.seiko-watch.co.jp/press/baseworld/prb_{—}2005/04.html>
[Patent Literature 1] Japanese Patent Application Laid-Open No. 2000-209319
[Patent Literature 2] Utility Model Registration No. 3096593

However, the problem with these wristwatch-type electronic devices and bracelet-style electronic devices is that they have a thick display unit and it is difficult to make them thinner.

Also, since an internal module must be housed inside the curved case structure in a wristwatch having the above-described case structure, the front surface of one case body must be mounted to superpose on the back surface of another case body either directly or through packing in order to ensure ease of assembly and ease of maintenance. In this case, problems may not occur in cases in which the range of center angles of the two case bodies is small, but if the range of center angle of the two case bodies is large, then problems are encountered when the two case bodies are superposed. In this case the surfaces around the ends of the case bodies scrape against and scratch each other, or the packing near the ends deforms due to the stress in the direction of curvature along the front surface or the back surface, and breaks out of the packing box, making it impossible to achieve a normal sealed state. Such conditions become particularly pronounced when the radius of curvature near the ends of the case bodies is greater than in the middle.

The present invention was designed in view of such circumstances, and an object thereof is to provide a wearable electronic device that can be made thinner.

Another object of the present invention is to provide a method for manufacturing a portable device that is mounted with two case bodies being superposed on each other, wherein the device is assembled unimpeded regardless of the curved shape of the case bodies.

### SUMMARY OF THE INVENTION

In order to achieve these objects, the present invention includes a frame body that has a ring shape or a substantial C-shaped in cross section, and is mounted on the body of a user; a strip-shaped display panel disposed along the peripheral surface of the frame body; and a drive circuit for driving the display panel; wherein the display panel and the drive circuit are provided to mutually different circuit boards, and the circuit boards are disposed along the peripheral surface of the frame body so as not to be superposed on each other, or the display panel and the drive circuit are both provided to one circuit board without being superposed on each other and are disposed along the peripheral surface of the frame body.

In this wearable electronic device, the thickness can be reduced because the display panel and the drive circuit are provided to mutually different circuit boards, and the circuit boards are disposed along the peripheral surface of the frame body so as not to be superposed on each other, or the display panel and the drive circuit are both provided to one circuit board without being superposed on each other and are disposed along the peripheral surface of the frame body.

Particularly, a configuration wherein the display panel and the drive circuit are provided to mutually different circuit boards makes it possible to improve the yield rate during manufacturing because these components can be manufactured separately, resulting in lower manufacturing costs.

To achieve the objects described above, the present invention also provides a method for manufacturing a portable device including a frame body that has a ring shape or a substantial C-shaped in cross section, and is mounted on the body of a user; a strip-shaped display panel disposed along the peripheral surface of the frame body; and a drive circuit for driving the display panel; wherein the frame body is configured from a first case body having a convex front-surface shape curved in a specific direction, and a second case body having a concave back-surface shape curved in the same specific direction; the display panel and the drive circuit are provided to mutually different circuit boards, and the circuit boards are disposed along the peripheral surface of the second case body so as not to be superposed on each other, or the display panel and the drive circuit are both provided to one circuit board without being superposed on each other and are disposed along the peripheral surface of the second case body; and the front surface of the first case body and the back surface of the second case body are superposed and mounted so as to be either directly or indirectly bonded together in an orientation in which there is a match between the directions of curvature thereof.

According to the present invention, the thickness can be reduced because the display panel and the drive circuit are provided to mutually different circuit boards, and the circuit boards are disposed along the peripheral surface of the frame body so as not to be superposed on each other, or the display panel and the drive circuit are both provided to one circuit board without being superposed on each other and are disposed along the peripheral surface of the frame body, similar to the wearable electronic device according to the present invention.

Furthermore, in order to achieve the objects described above, the method for manufacturing the portable device in accordance with the present invention is a method in which a first case body having a convex front-surface shape curved in a specific direction, and a second case body having a concave back-surface shape curved in the same specific direction are superposed and mounted so that the front surface of the first case body and the back surface of the second case body are either directly or indirectly bonded together in an orientation in which there is a match between the directions of curvature thereof, wherein the first case body is elastic in the direction of curvature, at least part of the front surface of the first case body is directly or indirectly brought into contact with the back surface of the second case body in a state in which the first case body is deformed so that the radius of curvature of the shape of the front-surface shape is increased, and the first case body and the second case body are then superposed and mounted by releasing the deformation stress on the first case body.

According to this invention, at least part of the front surface of the first case body is directly or indirectly brought into contact with the back surface of the second case body in a state in which the first case body is elastically deformed to increase the radius of curvature, and the deformation stress on the first case body is then released, whereby the first case body and the second case body can be superposed and mounted by reducing the radius of curvature of the first case body by means of elastic recoil. Therefore, a regular mounted state can be more reliably obtained regardless of the curved shapes of the first case body and the second case body because scratching on the contact surfaces of the case bodies and deformation or loss of the packing can be reduced.

Another method for manufacturing a portable device of the present invention is a method in which a first case body having a convex front-surface shape curved in a specific direction, and a second case body having a concave back-surface shape curved in the same specific direction are superposed and mounted so that the front surface of the first case body and the back surface of the second case body are either directly or indirectly bonded together in an orientation in which there is a match between the directions of curvature thereof, wherein the second case body is elastic in the direction of curvature, at least part of the front surface of the first case body is directly or indirectly brought into contact with the back surface of the second case body in a state in which the second case body is deformed so that the radius of curvature of shape of the front surface is reduced, and the first case body and the second case body are then superposed and mounted by releasing the deformation stress on the second case body.

According to this invention, at least part of the front surface of the first case body is directly or indirectly brought into contact with the back surface of the second case body in a state in which the second case body is elastically deformed to increase the radius of curvature of the back surface, and the deformation stress on the second case body is then released, whereby the first case body and the second case body can be superposed and mounted by increasing the radius of curvature of the back surface of the second case body by means of elastic recoil. Therefore, a regular mounted state can be more reliably obtained regardless of the curved shapes of the first case body and the second case body because scratching on the contact surfaces of the case bodies and deformation or loss of the packing can be reduced.

Next, in the portable device of the present invention, a first case body having a convex front-surface shape curved in a specific direction, and a second case body having a concave back-surface shape curved in the same specific direction are superposed and mounted so that the front surface of the first case body and the back surface of the second case body are either directly or indirectly bonded together in an orientation in which there is a match between the directions of curvature thereof, at least one case body selected from the first case body and the second case body is elastic in the direction of curvature, and stress is applied by the elasticity of at least one of the case bodies in the direction in which the front surface of the first case body and the back surface of the second case body are bonded together.

According to this invention, stress is applied by the elasticity of at least one of the case bodies in the direction in which the front surface of the first case body and the back surface of the second case body are bonded together, whereby stability can be ensured in the superposed and mounted state of the first case body and the second case body, the uniformity of the bonded state between the front surface of the first case body and the back surface of the second case body can be improved, and the airtightness and watertightness can be increased.

According to the present invention, thickness can be reduced because the display panel and the drive circuit are provided to mutually different circuit boards, and the circuit boards are disposed along the peripheral surface of the frame body without being superposed on each other.

In the method for manufacturing a portable device made by superposing and mounting the two case bodies in accordance with the present invention, excellent results can be achieved because the device can be assembled unimpeded, regardless of the curved shapes of the case bodies.

### BRIEF DESCRIPTION OF THE DRAWINGS

FIG. 1 is a four-sided view of a wearable electronic device relating to the first embodiment of the present invention;

FIG. 2 is a cross-sectional view of a wearable electronic device;

FIG. 3 is a plan view showing the configuration of a display unit;

FIG. 4 is a diagram for describing the assembly of a display unit;

FIG. 5 is a diagram showing the relationship between the arrangement of a button operating unit and a control circuit board;

FIG. 6 is a diagram showing an enlarged view of the connecting portion between the display panel substrate and the control circuit board;

FIG. 7 is a schematic perspective view of a portable device manufactured according to the second embodiment;

FIG. 8 is a schematic longitudinal cross-sectional view showing the cross-sectional structure of the portable device along the direction of curvature;

FIGS. 9(a) to 9(e) are cross-sectional view showing the cross-sectional structure of the portions shown in Sa to Se in FIG. 14 in the width direction;

FIG. 10 is a schematic plan view showing part of the base member of the portable device;

FIG. 11 is a schematic plan view of the internal module of the portable device;

FIG. 12 is a schematic perspective view showing the exposed portion after one cover member has been removed from the portable device;

FIG. 13 is a schematic explanatory diagram showing a basic depiction of the states before mounting and after mounting in a portable device manufactured according to the embodiments;

FIGS. 14(A-1) to 14(A-3) and 14(B-1) to 14(B-3) are a schematic process diagrams showing a basic depiction of the manufacturing process in the two embodiments;

FIG. 15 is a schematic perspective view showing the shape of the packing when it is mounted; and

FIG. 16 is a diagram showing another aspect of the cover member of the portable device.

### DESCRIPTION OF THE PREFERRED EMBODIMENTS

Embodiments of the present invention are described below with reference to the diagrams.

### First Embodiment

In the present embodiment, a wrist-worn electronic device, which is one aspect of the portable device, will be described.

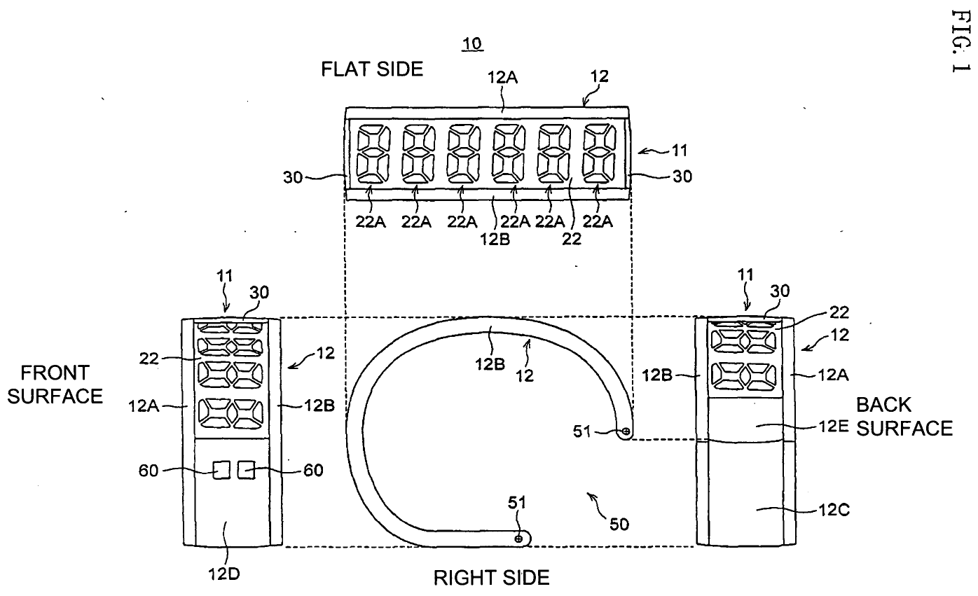

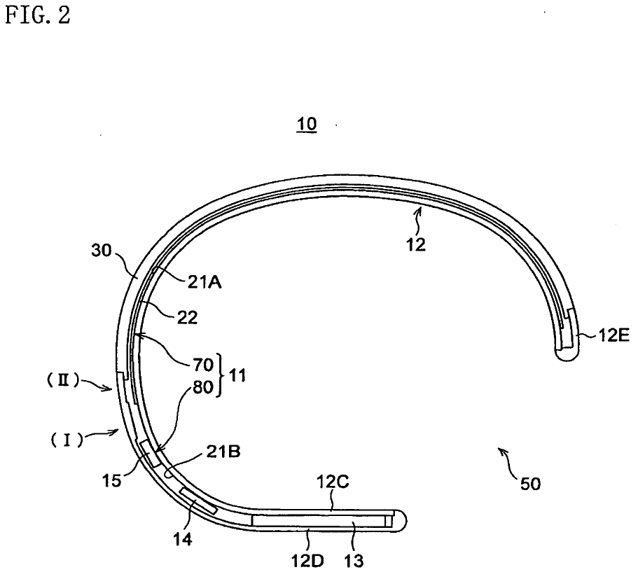

FIG. 1 is a four-sided view showing a right side view, a plan view, a front view, and a back view of a wrist-worn electronic device 10 according to the present embodiment, and FIG. 2 is a cross-sectional view of the wrist-worn electronic device 10. As shown in these diagrams, the wrist-worn electronic device 10 includes a display unit 11 and a frame body 12.

The frame body 12 is formed into a substantial C-shape in cross section, has a separated part 50 for fitting onto the arm or wrist of the user when mounted, and includes a left-side frame body 12A and right-side frame body 12B, a back lid 12C, and exterior bodies 12D and 12E, as shown in FIGS. 1 and 2.

The left-side frame body 12A and the right-side frame body 12B are frames that constitute the left and right sides of the wrist-worn electronic device 10, and the display unit 11 is held between this pair of left- and right-side frame bodies 12A and 12B.

The back lid 12C constitutes the back surface of the wrist-worn electronic device 10, has a long strip-shaped plate formed into a substantial C shape in cross section, and is fixed in place by the pair of left- and right-side frame bodies 12A and 12B and by screws 51.

The exterior bodies 12D and 12E are provided to the ends of the separated part 50, and constitute the exterior of the ends of the separated part 50. Of these two exterior bodies 12D and 12E, the exterior body 12D is provided with a pushbutton operating element 60.

The display unit 11 includes a display panel 22 formed into a strip shape. This display panel 22 curves along the peripheral surface of the frame body 12 and is disposed so as to be positioned between the exterior body 12D and the exterior body 12E. Also, the display panel 22 remains visible while its entire length is covered by a substantially transparent cover member 30 formed from a transparent resin or transparent glass, and the display panel is protected by this cover member 30. In the present embodiment, the display panel 22 is provided with a plurality of seven-segments 22A, and the current time is displayed by these seven-segments 22A.

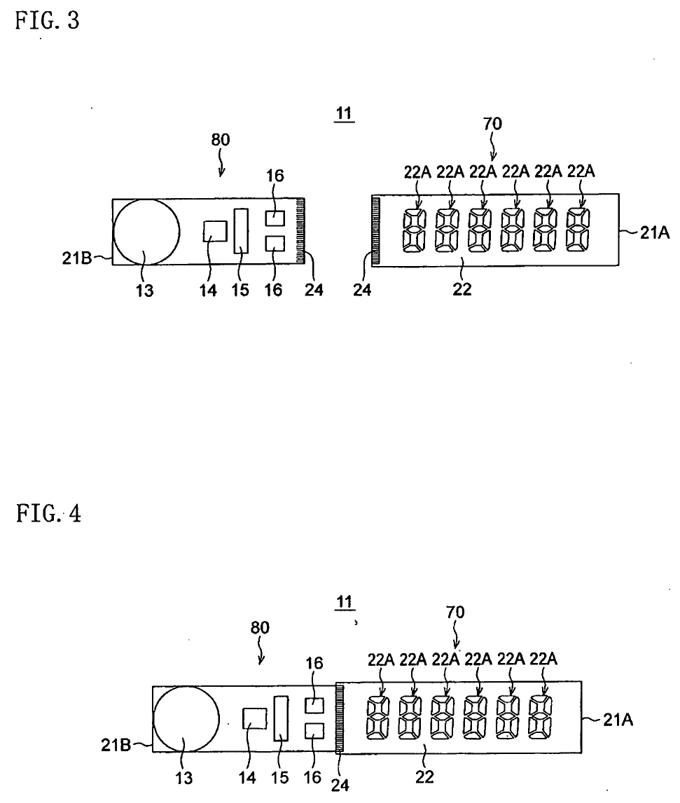

FIG. 3 is a plan view showing the configuration of the display unit 11.

As shown in this diagram, the display unit 11 includes two substrates: a display panel substrate 70 that is provided with the display panel 22 and constitutes a display unit, and a control circuit board 80 for controlling the display panel 22. The display panel substrate 70 and the control circuit board 80 include flexible (circuit) substrates (FPCs: flexible printed circuits) 21A and 21B made by forming a resin (plastic: using polyimide, polyester, or the like) or other flexible material into strip shapes, and various circuits are mounted on these flexible substrates 21A and 21B.

Specifically, in the display panel substrate 70, a flexible strip-shaped display panel 22 is provided to the flexible substrate 21A. In the present embodiment, an electrophoretic display panel is used as the display panel 22, the plurality of seven-segments 22A for displaying the numerals 0 through 9 are arrayed in the longitudinal direction, and the time or other information is displayed by the seven-segments 22A. Other possibilities for the display panel 22 include forming a liquid-crystal display panel or an organic EL (electroluminescence) display panel on a plastic piece, or polishing the panel and forming it into a bendable structure.

A power source 13 for supplying electricity to all components, a controller 14 for controlling the entire wrist-worn electronic device 10, a driver IC (drive circuit) 15 for controlling the display of the display panel 22, and switching terminals 16 are arranged without being superposed on each other on the flexible substrate 21B of the control circuit board 80. These components extend from one end to the other of the control circuit board 80. The order in which these electric circuits are arranged on the flexible substrate 21B is arbitrary. For example, the switching terminals 16 may be provided between the power source 13 and the controller 14.

A button battery, which is a regular primary battery, is used as the power source 13, and the socket in which this button battery is mounted is provided to the end of the flexible substrate 21B.

The controller 14 is configured as a so-called microcomputer, and this controller includes MPU, ROM, RAM, and the like (not shown). The MPU performs processes on the basis of a control program stored in advance in the ROM to control all the components of the wrist-worn electronic device 10. Also, the controller 14 has an oscillator (not shown), produces a reference clock, and executes a timekeeping operation for the time on the basis of this reference clock.

The switching terminals 16 are contact terminals formed on the flexible substrate 21B. These terminals are energized and turned on when the button operating element 60 is pushed, and an on signal is accordingly inputted to the controller 14.

When the button operating element 60 is operated and an on signal is inputted, the controller 14 executes an operation that corresponds to the operation of the button, such as a time correction operation.

Based on the timekeeping operation of the controller 14, the driver IC 15 outputs a display control signal to instruct the display panel 22 to display the current time.

The display panel substrate 70 and the control circuit board 80 are manufactured separately, and are connected to each other by connectors 24 provided to one end each of the display panel substrate 70 and the control circuit board 80. In the present embodiment, an ACF (anisotropic conductive film) or other OLB (outer lead bonding) is used for the connectors 24. Specifically, when an ACF is used for the connectors 24, the ACF is attached to one end each of the display panel substrate 70 and the control circuit board 80 to form connectors 24, and the display panel substrate 70 and the control circuit board 80 are connected to each other by superposing and heat-crimping the connectors, as shown in FIG. 4. This connection allows for electric conduction between the display panel substrate 70 and the control circuit board 80, and makes it possible for the display control signal outputted from the controller 14 to be inputted to the display panel substrate 70 via the connectors 24, and the display panel 22 to be driven based on this display control signal.

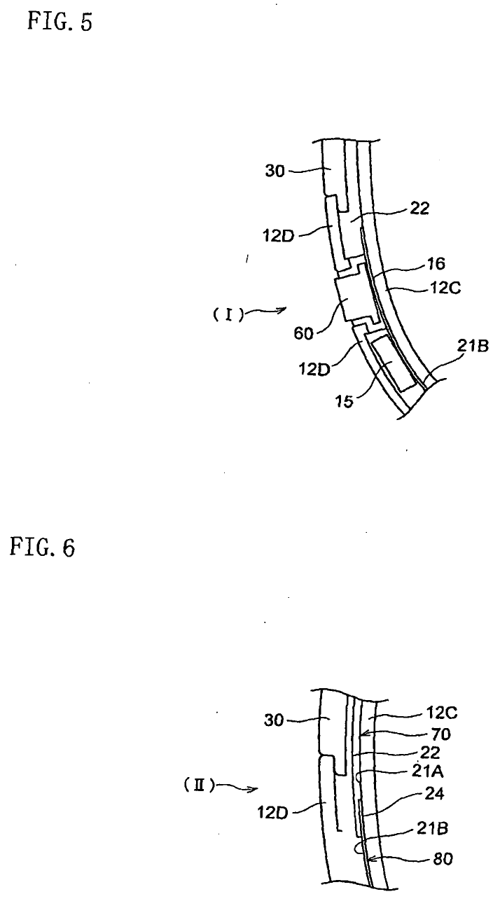

As shown in FIG. 2, the display unit 11 configured as described above is provided to the inner surface of the curved back lid 12C and extends along substantially the entire periphery of the frame body 12. At this time, the exterior body 12D is positioned above the control circuit board 80 of the display unit 11. Therefore, removing the exterior body 12D exposes the button battery, which is the power source 13 of the control circuit board 80, and allows the button battery to be replaced. Also, as shown in FIG. 5, the switching terminals 16 are positioned directly below the pushbutton operating element 60 provided to the exterior body 12D. Furthermore, as shown in FIGS. 2 and 6, the exterior body 12D covers the control circuit board 80 from the end of the separated part 50, and extends to a point above the location where the display panel substrate 70 and control circuit board 80 are connected by the connectors 24, connecting the entire display panel 22 to the cover member 30.

As described above, the display panel substrate 70 and the control circuit board 80 are connected by the connectors 24 provided to one end of each, forming the strip-shaped display unit 11 as a whole, and this strip-shaped display unit 11 is disposed along the peripheral surface of the frame body 12 (more accurately, the inner periphery of the back lid 12C). This configuration allows the wrist-worn electronic device 10 to be made thinner because the display panel substrate 70 and the control circuit board 80 are not superposed on each other.

According to the present embodiment, the display panel substrate 70 and the control circuit board 80 are disposed along the peripheral surface of the frame body 12 without being superposed on each other, and the thickness of the wrist-worn electronic device 10 can therefore be reduced.

Also, according to the present embodiment, since the display panel substrate 70 and the control circuit board 80 are configured from different substrates, they can be manufactured separately. Therefore, the yield rate of manufacturing can be improved, resulting in reduced manufacturing costs.

Also, according to the present embodiment, since the power source 13, the controller 14, the driver IC (drive circuit) 15, and the switching terminals 16 are disposed on the control circuit board 80 without being superposed on each other, the thickness of the control circuit board 80 can be reduced, and the wrist-worn electronic device 10 can thereby be made thinner.

Also, since the thickness of the control circuit board 80 is reduced in this manner, a so-called headless exterior structure is made possible, in which the exterior body 12D disposed so as to cover the control circuit board 80 does not protrude in the thickness direction of the frame body 12.

The present embodiment ultimately depicts one aspect of the present invention, and various arbitrary modifications and applications are possible within the range of the present invention.

For example, in the present embodiment, a configuration was exemplified wherein a button battery, which is a primary battery, was used as the power source 13, but the present invention is not limited thereto, and a secondary battery can also be used. It is preferable that a flexible lithium polymer battery or the like, for example, be used as this secondary battery. Also, when a secondary battery is used as the power source 13, one possibility for the system of charging the secondary battery is, as is customary, to provide a charging terminal to the frame body 12, and to charge the secondary battery by applying a charge voltage to the charging terminal. Another possibility is a configuration wherein electricity is wirelessly supplied to the secondary battery by electromagnetic induction or another system.

Yet another possibility is a configuration wherein a wireless communication unit or other device capable of wireless communication with an external computer terminal is provided to the wrist-worn electronic device 10 described above, and a display based on data obtained from this communication is enabled on the display panel 22.

Also, for example, the shape of the frame body 10 of the wrist-worn electronic device 10 in the present embodiment is a substantial C-shape in cross section, but this is not the only possible option. Specifically, as long as the device can be worn by a user, the shape may be a ring shape, for example, or at least a ring shape when worn.

The frame body 10 is preferably configured from a first case body having a curved convex front-surface shape, and a second case body having a concave back-surface shape curved in a specific direction.

Also, the display panel substrate 70 and the control circuit board 80 may be disposed on one circuit board and arranged along the peripheral surface of the frame body 10 without being superposed on each other.

### Second Embodiment

Next, the second embodiment of the present invention will be described in detail.

In this embodiment, a method for manufacturing the wrist-worn electronic device 10 described in the first embodiment or another portable device (electronic device), and a portable device manufactured by implementing this manufacturing method are described.

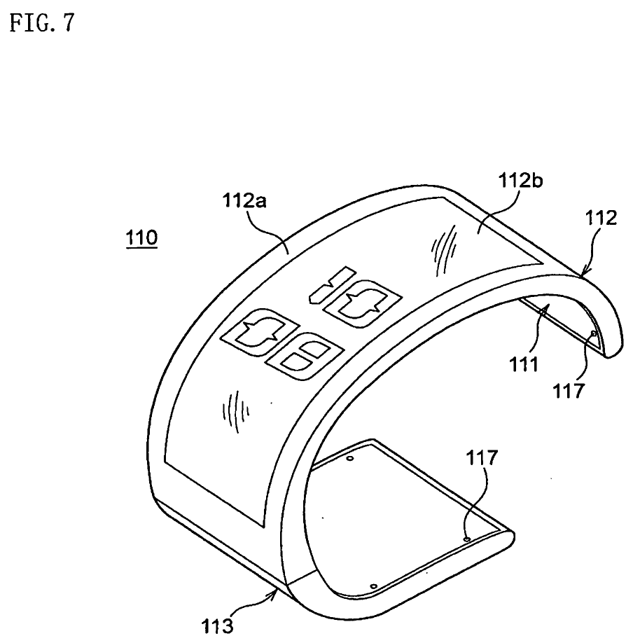

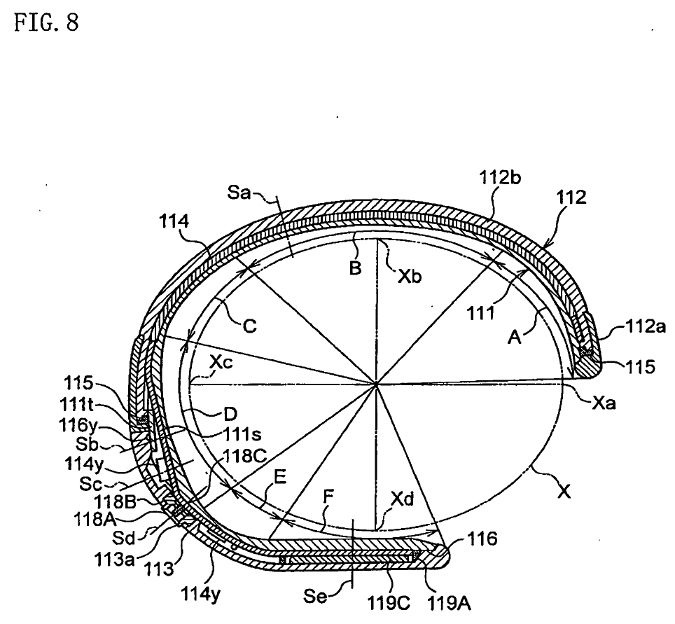

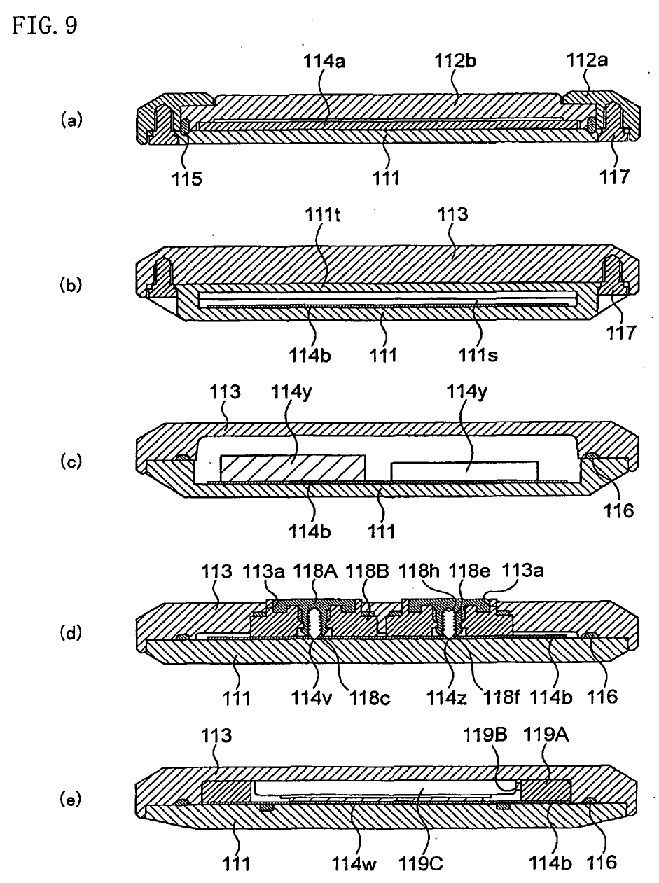

FIG. 7 is a schematic perspective view showing the structure of a portable device manufactured according to an embodiment of the method for manufacturing a portable device according to the present invention, FIG. 8 is a longitudinal cross-sectional view showing a cross section along the direction of curvature of the same portable device, and FIGS. 9(a) to 9(e) are cross-sectional views showing the cross-sectional structures of the portions Sa to Se shown in FIG. 2. This portable device 110 is a wearable device that is used while worn by a person, and is also an electronic device equipped with electric circuits in the interior. More specifically, this device is a wrist-worn electronic device that is used while worn on the wrist. Possible examples of this wrist-worn electronic device include wristwatches, diver's computers, stopwatches, sphygmomanometers, and other body sensing devices, but the specific functions of these devices are not described herein.

The portable device 110 includes a curved strip-shaped base member 111 and two cover members 112 and 113 mounted on the front surface of the base member 111, as members (exterior members) constituting the case structure. Also, an internal module 114 is held inside the case structure formed by the base member 111 and the cover members 112 and 113.

The base member 111 is composed of stainless steel or another metal, or a synthetic resin or the like, and is sufficiently rigid to support the curved shape by itself (specifically, as long as no stress greater than standard gravity is applied). The base member 111 is curved substantially into the shape of a C; that is, this member has a curved shape that mostly fits around the arm (the wrist in particular), or a shape curved in a substantial ellipse.

The base member 111 has a curved shape that runs substantially along the ellipse X shown in FIG. 8. When the center angle (the angle whose center is the point of intersection between the major axis and the minor axis) of the ellipse X at one point of intersection Xa with the major axis of the ellipse X is 0 degrees, the center angle extends within a range from 0 degrees to near 270 degrees (260 to 300 degrees). Specifically, the base member has a shape (substantially elliptical arcuate shape) running along the ellipse X, and this shape extends from the point of intersection Xa, passes through a point of intersection Xb with the minor axis and another point of intersection Xc with the major axis, and extends all the way to the vicinity of another point of intersection Xd with the minor axis.

More specifically, the front-surface shape of the base member 111 of the present embodiment is a shape obtained by connecting a plurality of arcuate portions having different radii of curvature. In other words, in the illustrated example, one end includes a curved section A with a rather small radius of curvature (a radius of curvature of about 22 to 26 mm), a curved section B that is connected to the curved section A that has a greater radius of curvature than the curved section A (a radius of curvature of about 47 to 51 mm), a curved section C that is connected to the curved section B that has a smaller radius of curvature than the curved section B (a radius of curvature of about 22 to 26 mm), a curved section D that is connected to the curved section C that has a greater radius of curvature than the curved section C (a radius of curvature of about 54 to 58 mm), a curved section E that is connected to the curved section D that has a smaller radius of curvature than the curved section D (a radius of curvature of about 22 to 26 mm), and a flat section F that is connected to the curved section E and has a flat configuration.

The base member 111 is sufficiently rigid to maintain its shape as described above, but it is preferable that this member also be elastic to a certain extent and be able to manually deform somewhat when being attached and removed. Also, the base member 111 can be manufactured by press working, forging, or the like, but in order to improve the precision of the curved shape, the base member is preferably manufactured by cutting a block (or plate) of a metal or another material into the curved shape described above by electrical discharge machining.

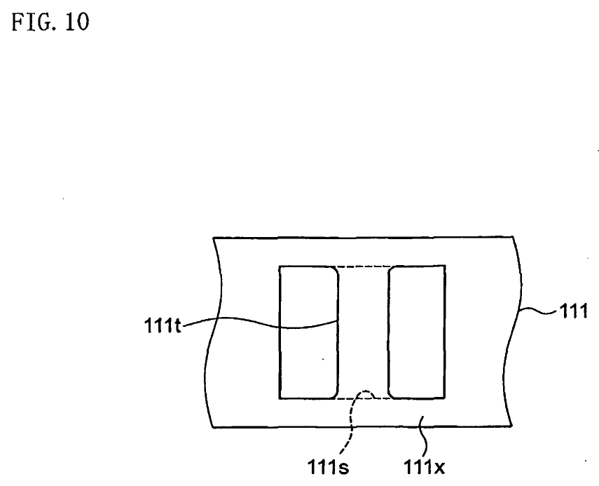

FIG. 10 is a plan view showing part of the base member 111. A bridging part 111t oriented so as to intersect (to be orthogonal in the illustrated example) with the direction of curvature (longitudinal direction) of the base member 111 is provided along part of the direction of curvature of the base member 111. This bridging part 111t is used together with a through-part 111s that passes through on the reverse side in the direction of curvature, as shown in FIG. 9(b). The bridging part 111t is formed in the middle section of the ellipse X in an area in which the center angle is about 200 degrees (180 to 220 degrees).

The bridging part 111t extends in the width direction of the base member 111, and both ends are connected to the outer edge 111x of the base member 111. This bridging part 111t can be formed by forming the through-part 111s in the base member. The through-part can be formed by cutting the front surfaces of the integrated members from both sides using a T-groove cutter or another tool. A through-hole can also be formed with a drill or another perforating tool in the portion where the through-part 111s is to be formed, and the bridging part 111t can be formed in the same manner as described above by wire cutting while a wire is passed through the through-hole. Furthermore, the bridging part 111t may be created separately from the base member 111, and may be fixed in place to the base member 111 by welding, deposition, adhesion, or another arbitrary method.

The front surface of the bridging part 111t is shaped so as to continue onto the outer edge 111x of the base member 111. In the illustrated example, the front surface of the bridging part 111t is flat in the width direction (in the vertical direction in FIG. 10), and is curved mostly along the curved shape of the entire base member 111 in the direction of curvature (the horizontal direction in FIG. 10). The bridging part 111t and the outer edge 111x of the base member 111 to which the bridging part is connected should have continuous surface shapes; for example, the front surface of the bridging part 111t may be flat. The term “continuous front-surface” indicates that the surface does not have a curved part whose radius of curvature falls short of the range in which sealing can be provided using common packing.

The cover member 112 is configured so as to extend across a range in which the center angle of the ellipse X varies from 0 degrees to near 200 degrees (180 to 220 degrees). The cover member is mounted on the front surface of the base member 111 within this range. The cover member 112 has a frame 112a composed of a synthetic resin or a metal such as stainless steel, and also has a display window 112b disposed on the inner side of the frame 112a. The display window 112b is composed of a transparent material (glass or a transparent resin) fitted into and fixed in place on the frame 112a. The display window 112b may be configured from an opening where no material is present, or the entire cover member 112 may be composed of a transparent material. The display member 114a of the below-described internal module 114 is configured so as to be visible through the display window 112b, as shown in FIG. 9(a).

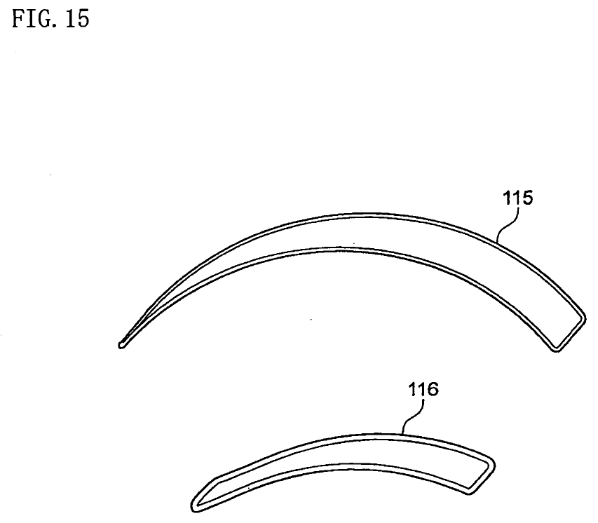

A packing box is provided to the outer edge of the back surface of the cover member 112, closed curve-shaped (rectangular frame-shaped) packing 115 (see FIG. 15) is held in this packing box, and the base member 111 and the cover member 112 are bonded together via this packing 115. The base member 111 and the cover member 112 can be bonded together via the packing 115 in a variety of ways, such as when the packing 115 is held in the packing box provided to the base member 111. The base member 111 and the cover member 112 are then fixed in place with a setscrew 117.

A packing box similar to the one described above is also provided to the outer edge of the back surface of the cover member 113, packing 116 shaped as a closed curve (rectangular frame) (see FIG. 15) is held in this packing box, and the base member 111 and the cover member 113 are bonded together via this packing 116. The base member 111 and the cover member 113 can be bonded together via the packing 116 in a variety of ways, such as that the packing 116 is held in the packing box provided to the base member 111. The base member 111 and the cover member 112 are then fixed in place with a setscrew 117.

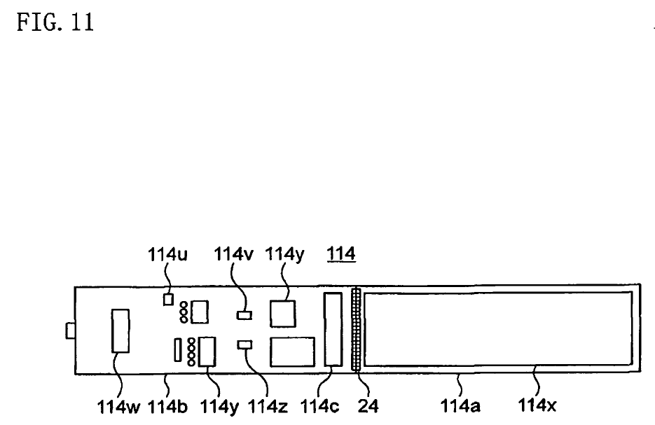

FIG. 11 is a plan view of the internal module 114. The internal module 114 is shaped as a strip in which an electroconductive connection is established between the display member 114a and a wiring substrate 114b, and the entire module is flexible at least in the direction of curvature of the base member 111.

The display member 114a is made by forming transparent electrodes on the inner sides of two transparent flexible films, and placing the following substances between the flexible films: an electro-optical substance such as a transparent liquid, and a substance (for example, electronic ink made by E Ink Corporation) that contains numerous microcapsules filled with variously colored particles (for example, white particles and black particles) capable of moving towards opposite electrical fields. The display member 114a can be caused to form the desired display with a high contrast by a change in the polarity of the voltage applied between the transparent electrodes. The display member 114a includes a strip-shaped display section 114x that extends in the direction of curvature of the base member 111. The display member 114a may be configured from a liquid crystal display panel or an organo-luminescent panel.

The wiring substrate 114b is a flexible substrate made from a polyimide resin or the like, and the wiring is formed either on the substrate or inside the substrate. A terminal unit 114c, to which the terminal of the display member 114a is connected by electrical conduction, is provided to the end of the wiring substrate 114b. An IC chip or another electronic component 114y is mounted on the front surface of the wiring substrate 114b. Furthermore, switch-connecting electrodes (pads) 114z and 114v are provided to the front surface of the wiring substrate 114b, and battery-connecting electrodes (pads) 114w and 114u are also formed.

The connectors 24 described in the first embodiment are provided to one end each of the display member 114a and the wiring substrate 114b, which are connected to each other by means of these connectors 24. Thus, the thickness of the internal module 114 can be reduced, and the portable device 110 can be made thinner because the display member 114a and the wiring substrate 114b are disposed without being superposed on each other.

The internal module 114 is held between the base member 111 and the cover members 112 and 113 so that the display member 114a is disposed inside the cover member 112, and the wiring substrate 114b is disposed inside the cover member 113. The internal module 114 is disposed so as to pass via the through-part 111s formed on the reverse side of the bridging part 111t of the base member 111, and to extend to both sides of the bridging part 111t in the direction of curvature, as shown in FIG. 9(b). It is preferable that in the wiring substrate 114b of the internal module 114, the section provided with the terminal unit 114c, which is connected by electrical conduction to the display member 114a, is inserted through the through-part 111s. Part of the display member 114a is thereby no longer covered by the bridging part 111t, and it is possible to avoid the section where the electronic component 114y is mounted in the wiring substrate 114b, the section where the switch-connecting electrodes 114z and 114v are formed, and other such areas. Therefore, since the through-part 111s can be reduced in thickness, the portion to which the bridging part 111t is provided, that is, the section where the bridging part 111t and the through-part 111s are both formed in the thickness direction, can be reduced in thickness.

In the illustrated example, the inner bottom side that faces the through-part 111s has a flat shape in order to simplify processing and to simplify the operation of inserting the internal module 114, but this inner bottom side may also be formed into a curved surface corresponding to the curved shape of the base member 111.

The front surface of the bridging part 111t is bonded to the ends of the cover members 112 and 113 via the packing 115 and 116. The front surface of the bridging part 111t is connected to the outer edge of the base member 111 as described above. Therefore, gaps are not likely to form between the packing 115 and 116 and the outer edges of the bridging part 111t and base member 111, for which reason both the internal gaps in the case structure formed by the base member 111 and the cover member 112, and the internal gaps in the case structure formed by the base member 111 and the cover member 113 are reliably sealed.

The cover member 113 is provided with an opening 113a. The following components are mounted in (fitted and fixed in place in) this opening 113a: a switch terminal 118A connected by electrical conduction to the electrodes 114z and 114v formed on the wiring substrate 114b, and an insulating frame 118B made from a synthetic resin or the like formed in a frame shape between the switch terminal 118A and the cover member 113. The switch terminal 118A is in electrical contact with the electrodes 114z and 114v via a coil spring 118C. The coil spring 118C has a cylindrical portion 118e held inside an accommodating hole 118h that opens in the bottom of the switch terminal 118A, and a truncated cone-shaped portion 118f that is connected to the bottom part of the portion 118e and narrows downward. The truncated cone-shaped portion 118f is supported so as to not fall out of the edge of the opening in the accommodating hole 118h.

The coil spring 118C is held in the accommodating hole 118h in a compressed state so that the spiraled coil structure exhibits elasticity sufficient to ensure contact pressure with electrical conduction in the cylindrical portion 118e, and the truncated cone-shaped portion 118f is configured so as to be always tightly wound, with the distal end in contact with the electrodes 114z and 114v. The truncated cone-shaped portion 118f is always tightly wound, and is thereby prevented from changing its shape, whereby stable contact with electrical conduction is ensured between the electrodes 114z and 114v.

When the user touches the switch terminal 118A and the surrounding cover member 113 with their finger, the electrodes 114z and 114v in electrical contact with the switch terminal 118A change their electric potential and the switch operation is detected, whereby a specific operation, such as switching or setting the display contents of the display member, is conducted by specific circuits provided to the wiring substrate 114b.

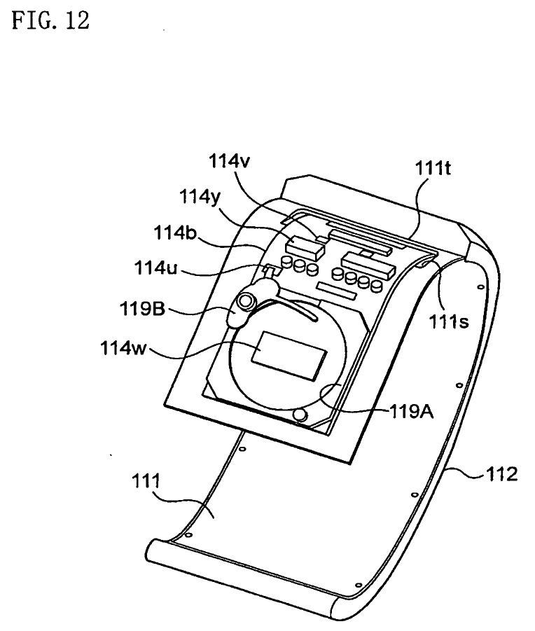

FIG. 12 is a schematic perspective view showing the exposed region when the cover member 115 is removed. A battery holding frame 119A and an electrode terminal 119B are fixed in place on the wiring substrate 114b. When the battery 119C shown in FIGS. 7 and 9(e) is held in the battery holding frame 119A, the electrode provided to the bottom surface of the battery 119C comes into contact by electrical conduction with the electrode 114w provided to the wiring substrate 114b, and the electrode provided to the side surface of the battery 119C is in electrical contact with the electrode 114u on the wiring substrate 114b via the electrode terminal 119B.

The cover member 113 is provided with an irregularly shaped inner surface that matches the thickness of the wiring substrate 114b, whereby the internal gaps formed by the base member 111 and the cover member 113 differ in thickness depending on the location. For example, as shown in FIG. 9(c), the internal gap is ensured to have a large thickness in the portion where the electronic component 114y is mounted on the wiring substrate 114b, but the thickness of the internal gap in the portion where the electronic component 114y is not mounted is somewhat greater than the thickness of the wiring substrate 114b, as shown in FIG. 9(d).

The portable device 110 described above can be placed on the arm (particularly on the wrist) by means of the open section of the curved shape of the portable device 110, which is curved into a substantial C shape. Unlike conventional wristwatches, diver's computers, and other such wrist-worn portable devices, a very original design can be achieved. In this design, the device is shaped as a strip (bracelet shape) that fits around the mounting area (the arm). A display section that is long in the direction of curvature along the mounting area can be ensured, and the device can be reduced in size and made thinner. Furthermore, since the internal module 114 is configured integrally, the number of components is reduced, and the assembly operation is simplified. The internal module 114 is entirely flexible in the direction of curvature (specifically, both the display member 114a and the wiring substrate 114b are flexible in the direction of curvature), and it can therefore be held in the interior in a state suitable to the case structure.

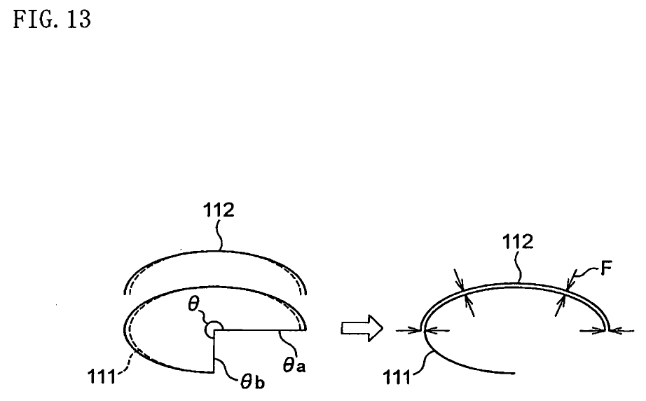

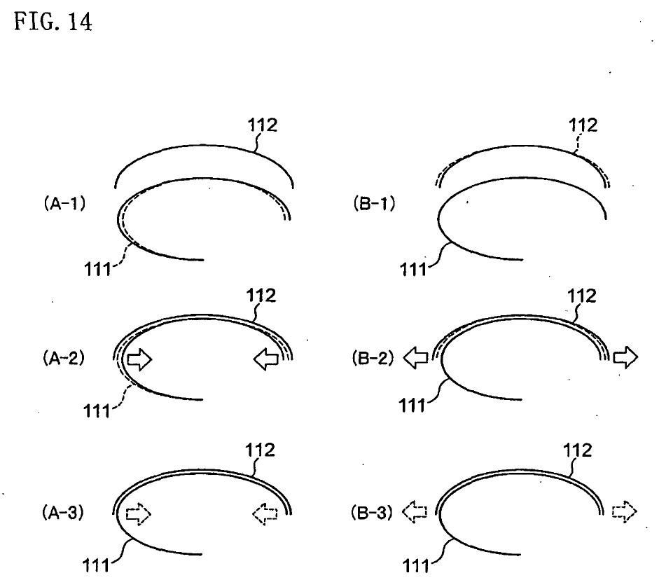

Next, an embodiment of the method for manufacturing the portable device according to the present invention will be described with reference to FIGS. 13 and 14. FIG. 13 is a schematic cross-sectional view showing the state before the base member 111 (first case body) and the cover member 112 (second case body) are mounted in the manufacturing process of the portable device 110 (left side of FIG. 13), and also the state after the base member 111 and the cover member 112 have been mounted (right side of FIG. 13).

In the present specification, the curvature distribution in the direction of curvature is used as one index of the curved shape. Specifically, the curved shape in the present invention is not limited to an arcuate shape having a simple curvature (or radius of curvature), and other possibilities include various other shapes, such as a shape wherein arcuate portions with different curvatures (radii of curvatures) are connected to each other, or a shape wherein the curvature (radius of curvature) varies continuously.

It is possible to envision a first curve that expresses the convex curved shape of the mounting portion (the curved portion mounted on the second case body) on the front surface of the first case body (the base member 111), and a second curve that expresses the concave curved shape of the mounting portion (the curved portion mounted on the first case body) on the back surface of the second case body (the cover member 112). In this case, the first curve and the second curve will essentially have substantially corresponding curved shapes and lengths. If the first curve and the second curve completely coincide at this time, then no elastic force is exerted between the cases by elastic deformation when the first case body and the second case body are superposed and mounted. Also, if the curvature distribution of the first curve is smaller on the whole than the curvature distribution of the second curve, then superposing and mounting the first case body and the second case body will result in a state in which at least some elastic force is exerted in the direction in which the cases are bonded together.

Another feature of the present specification, the center-angle range θ of the curved surface is used as another index indicating the curved shapes of the front surface or the back surface (curved surface) of the base member 111, the cover members 112 and 113, and the other case members. This center-angle range θ indicates the range of azimuth angles of a line that is normal to the curved surface. When the curved shape of the base member 111 is assumed to have a completely elliptical shape (elliptic arc) as shown in the left hand diagram in FIG. 13, the angle of intersection between two straight lines (the normal lines at the ends of the front surface of the base member 111 in the illustrated example) θa and θb that connect the center of the ellipse (the point of intersection between the minor axis and the major axis) with the end of the base member 111 is equivalent to the center-angle range θ. If the curved shape is an elliptic arc, other normal lines do not actually pass through the center of the ellipse except for the point of intersection with the minor axis and the point of intersection with the major axis. Also, the center-angle range θ still indicates the angle range of the normal lines of the curved surface even if the curved shape is not an elliptic arc.

The front surface of the base member 111 and the back surface of the cover member 112 essentially have mutually corresponding curved shapes, but their configuration is designed so that before they are mounted, the curvature (or the curvature distribution in the direction of curvature, same hereinbelow) of the front shape of the base member 111 is less than the curvature (or curvature distribution) of the back-surface shape of the cover member 112, that is, so that the average value of the radius of curvature along the direction of curvature is increased. The configuration herein is preferably designed so that the radius of curvature along the direction of curvature increases in a completely uniform manner, that is, so that the curvature distribution decreases uniformly throughout the entire range.

Also, at least one member selected from the base member 111 and the cover member 112 is elastic in the direction of curvature. In the present embodiment, configuring the base member 111 from an elastic metal or synthetic resin makes it possible to easily manufacture a base member 111 that is elastic in the direction in which the curvature (curvature distribution) varies. Also, a cover member 112 that is elastic in the direction in which the curvature (curvature distribution) varies can also be manufactured by configuring the display window 112b from an acrylic resin or another synthetic resin.

In the mounted state in the configuration described above, at least one member selected from the base member 111 and the cover member 112 is in an elastically deformed state, bringing about a state in which stress F in the bonding direction is applied by the elastic force between the front surface of the base member 111 and the back surface of the cover member 112. Therefore, the mounted state of the base member 111 and the cover member 112 is stabilized by this stress F, and the uniformity of the bonded state can be improved. Therefore, the airtightness from the packing 115 can be improved and a high degree of waterproofness can be obtained.

FIG. 14 is a schematic process diagram showing part of the manufacturing process of a portable device according to the present invention. FIG. 14 depicts two manufacturing processes, shown by (A-1) to (A-3) and (B-1) to (B-3).

In the manufacturing process shown in (A-1) to (A-3), the base member 111 is made elastic in the direction of curvature of the front-surface shape. As shown in FIG. 14(A-1), the front-surface shape of the base member 111 and the back-surface shape of the cover member 112 essentially have mutually corresponding curved shapes but are configured so that before they are mounted, the curvature (curvature distribution) of the front-surface shape of the base member 111 is equal to or less than the curvature (curvature distribution) of the back-surface shape of the cover member 112, that is, the average value of the radius of curvature along the direction of curvature of the front-surface shape of the base member 111 is equal to or greater than that of the back-surface shape of the cover member 112. The configuration used here is preferably designed so that the radius of curvature along the direction of curvature varies in a completely uniform manner, that is, so that the curvature distribution varies uniformly throughout the entire range. However, the curved shape of the front surface of the base member 111 and the curved shape of the back surface of the cover member 112 may also substantially coincide. In this case, when the base member 111 and the cover member 12 are superposed and mounted, the elastic force of the base member 111 is not exerted on the cover member 112.

Next, as shown in FIG. 14(A-2), applying external stress to the base member 111 in the direction from the front surface to the back surface creates elastic deformation in the direction in which the curvature of the front surface increases. External stress can be applied by a method of pulling the ends of the base member 111 in a direction that causes them to draw near each other, or by pressing on the base member 111. As a result, the curvature (or the curvature distribution) of the front-surface shape of the base member 111 can be increased to a level above the curvature (or curvature distribution) of the back-surface shape of the cover member 112, and the base member 111 can be held on the back surface of the cover member 112. The amount of elastic deformation in the base member 111 preferably remains uniform in the direction of curvature.

At least part of the front surface of the base member 111 is then brought into contact with the back surface of the cover member 112 either directly or through the packing 115. In the present embodiment, the packing 115 is placed between the base member 111 and the cover member 112. Therefore, at least part of the front surface of the base member 111 is in contact with the back surface of the cover member 112 through the packing 115, but if no packing 115 is used, then at least part of the front surface of the base member 111 can be brought into contact directly with the back surface of the cover member 112.

Furthermore, in the state described above, the curved shape of the base member 111 is elastically returned to its original state by releasing the external stress applied to the base member 111, as shown in FIG. 14(A-3). Therefore, the curvature (or curvature distribution) of the base member 111 is reduced, and the base member is mounted in a shape that conforms to the cover member 112. When the curvature (curvature distribution) of the front-surface shape of the base member 111 before mounting is less than the curvature (or curvature distribution) of the back-surface shape of the cover member 112, a state is established in which stress is applied by the elasticity of the base member 111 in the direction in which a tight bond is formed between the front surface of the base member 111 and the back surface of the cover member 112, as shown in FIG. 13.

A particular feature of the present embodiment is that the base member 111 can easily be elastically deformed by applying stress between the ends. This is because the base member 111 extends in a wider range in the direction of curvature than the cover member 112, and stress is therefore easily applied between the ends of the base member 111.

In the manufacturing process shown in (B-1)-(B-3), the cover member 112 is elastic in the direction of curvature. As shown in FIG. 14(B-1), the base member 111 and the cover member 112 essentially have mutually corresponding curved shapes, but the configuration is designed so that before they are mounted, the curvature (or curvature distribution) of the front-surface shape of the base member 111 is equal to or less than the curvature (or curvature distribution) of the back-surface shape of the cover member 112, that is, the average value of the radius of curvature along the direction of curvature of the front-surface shape of the base member 111 is equal to or greater than that of the back-surface shape of the cover member 112. The configuration herein is preferably designed so that the radius of curvature along the direction of curvature varies in a completely uniform manner, that is, so that the curvature distribution varies uniformly throughout the entire range. However, the curved shape of the front surface of the base member 111 and the curved shape of the back surface of the cover member 112 may also substantially coincide. In this case, when the base member 111 and the cover member 112 are superposed and mounted, the elastic force of the cover member 112 is not exerted on the base member 111.

Next, as shown in FIG. 14(B-2), applying external stress to the cover member 112 in the direction from the back surface to the front surface causes elastic deformation in the direction in which the curvature (or curvature distribution) decreases. External stress can be applied by a method of pulling apart the ends of the cover member 112 in a direction that causes them to separate from each other, or by pressing on the cover member 112. As a result, the curvature (or the curvature distribution) of the back-surface shape of the cover member 112 can be reduced to a level below the curvature (or curvature distribution) of the front-surface shape of the base member 111, and the base member 111 can be held on the back surface of the cover member 112. The amount of elastic deformation in the cover member 112 preferably remains uniform in the direction of curvature.

Then, at least part of the front surface of the base member 111 is brought into contact with the back surface of the cover member 112 either directly or through the packing 115. In the present embodiment, the packing 115 is placed between the base member 111 and the cover member 112. Therefore, at least part of the front surface of the base member 111 is in contact with the back surface of the cover member 112 through the packing 115, but if no packing 115 is used, then at least part of the front surface of the base member 111 can be brought into contact directly with the back surface of the cover member 112.

Furthermore, in the state described above, the curved shape of the cover member 112 is elastically returned to its original shape by releasing the external stress applied to the cover member 112, as shown in FIG. 14(B-3). Therefore the curvature (or curvature distribution) of the cover member 112 is increased, and the cover member is mounted in a shape that conforms to the base member 111. When the curvature (curvature distribution) of the front-surface shape of the base member 111 before mounting is less than the curvature (or curvature distribution) of the back-surface shape of the cover member 112, a state is established in which stress is applied by the elasticity of the cover member 112 in the direction in which a tight bond is formed between the front surface of the base member 111 and the back surface of the cover member 112, as shown in FIG. 13.

In the two manufacturing processes shown in FIG. 14, one case body selected from the base member 111 and the cover member 112 is configured from an elastic member and, and this case body is elastically deformed by applying external stress, but two case bodies selected from the base member 111 and the cover member 112 may also be configured from elastic members. Also, in this case, it is acceptable for only one of the case bodies to be elastically deformed, or for both of the case bodies to be elastically deformed.

In these manufacturing processes, since the internal module 114 must be accommodated within the case structure, the portable device 110 can be manufactured by mounting the base member 111 and the cover member 112 as described above, with the internal module 114 having been disposed between the base member 111 and the cover member 112 before mounting.

In these manufacturing processes, cases were described in which the cover member 112 was mounted on the base member 111, but another possibility is to mount the cover member 112, that is, the frame 112a on the base member 111 according to the manufacturing process before the display window 112b is attached, and then to affix the display window 112b to the frame 112a with an adhesive, or to fix it in place by press fitting. According to this method, since the cover member 112 is mounted on the base member 111 before the display window 112b is attached, the cover member 112 can be mounted on the base member 111 with less rigidity and greater elasticity. Possible examples for the material of the display window 112b include acrylic, ABS, polycarbonate, or another flexible synthetic resin with a high degree of transparency.

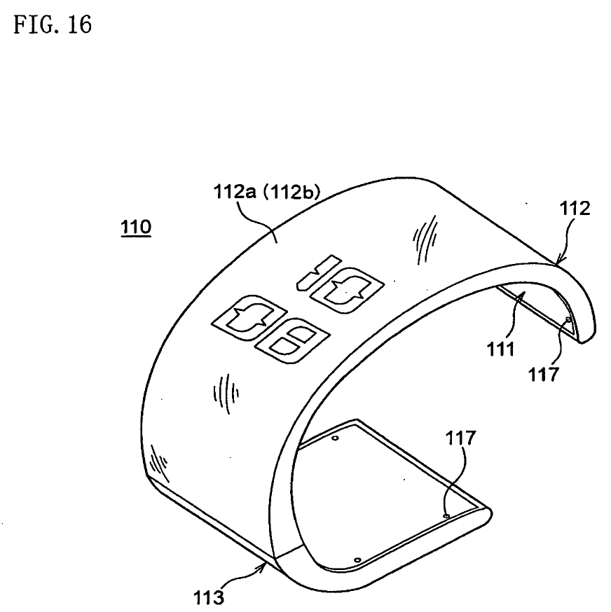

In the present embodiment, the cover member 112 is not limited to a configuration wherein the frame 112a and the display window 112b are separate, and may be configured with the frame 112a and the display window 112b molded integrally as shown in FIG. 16. According to this method, the manufacturing process is simplified because the steps of attaching the display window 112b to the frame 112a are omitted. In this configuration, it is preferable that a flexible material (for example, acryl, ABS, polycarbonate, or another synthetic resin) with a sufficient degree of transparency for the display window 112b be used as the cover member 112, and the surface of the region other than the display window 112b, that is, the region corresponding to the frame 112a, may be colored.

In the present embodiment, a flat panel display such as an electrophoretic display (EPD) or a liquid crystal display (LCD), or a flat panel display configured using an organic EL (OEL: organic electroluminescence) or another light emitting element can be used as the display member 114a that is visible through the display window 112b.

In the present embodiment, at least one case body of the base member 111 and the cover member 112 are configured from an elastic member, and external stress is applied to the one case member to bring it into direct or indirect contact with the other case member in a state of elastic deformation, and then even if the center-angle range of the curved shape of the case body increases due to removing the external stress, the base member 111 and the cover member 112 can be mounted unimpeded. Specifically, when the base member 111 and the cover member 112 are mounted via the packing 115 as described above, the packing 115 disposed near the end of the cover member 112 comes in contact with the base member 111, and instances of the packing 115 deforming or falling out of the packing box can be prevented as a result of the stress applied along the back surface of the cover member 112 by the base member 111; therefore, airtightness and watertightness can be improved.

Another feature of the present embodiment is that at least one of the case bodies is mounted on the other case body in an elastically deformed state. Therefore, the two case bodies can be mounted directly or indirectly unimpeded regardless of the curved shapes of the case bodies, particularly if the center-angle range of the curved shapes increases and the curved shapes become more complicated, or if the radii of curvature of the ends of the curved shapes decrease. Therefore, the restrictions on the curved shapes of the case bodies are reduced, and the portable device can be given various different designs.

The manufacturing method of the present embodiment becomes more effective with an increase in the center-angle range θ of the curved shapes on the front surface and back surface of the case bodies. A case can be considered in which the concave back surface of one case body is mounted in the convex front surface of another case body, and the center-angle range θ of the concave back surface of the first case body exceeds 180°. In this case, inserting the second case body into the back surface of the first case body can cause the elastic deformation that is brought about by the external stress in either of the case bodies and is necessary during assembly to be reduced by insertion in a direction (specifically, the lateral direction) that intersects the curved direction.

The portable device of the present invention is not limited to the examples illustrated above and can of course include various modifications within a range that does not deviate from the scope of the present invention. For example, the center-angle range of the case structure may be less than or greater than that of the embodiments as long as it has a curved shape. Also, the entire case structure need not be curved, and part of the structure may be flat. Furthermore, the opening portion in the curved shape may be configured with a detachable connecting tool, and the opening portion may be configured to be capable of closing. At least one cover member should be provided, but two or more cover members may be used as in the embodiments. Also, the present invention is not limited to a wrist-worn device as in the embodiments, and various other configurations are possible, including items such as hair bands that are worn on the head, for example.

The terms “front,” “back,” “up,” “down,” “perpendicular,” “horizontal,” “slanted,” and other direction-related terms used above indicate the directions in the diagrams used. Therefore, the direction-related terminology used to describe the present invention should be interpreted in relative terms as applied to the diagrams used.

“Substantially,” “essentially,” “about,” and other terms that are used above and represent an approximation indicate a reasonable amount of deviation that does not bring about a considerable change as a result. Terms that represent these approximations should be interpreted so as to include a minimum error of about ±5%, as long as there is no considerable change due to the deviation.

The disclosures in Japanese Patent Application No. 2005-60215, Japanese Patent Application No. 2005-238350, and Japanese Patent Application No. 2006-019555 are incorporated herein in their entirety by reference.

1. A wearable electronic device, comprising:
a frame body that has a ring shape or a substantial C-shaped in cross section, and is mounted on the body of a user;
a strip-shaped display panel disposed along the peripheral surface of the frame body; and
a drive circuit for driving the display panel; wherein
the display panel and the drive circuit are provided to mutually different circuit boards, and the circuit boards are disposed along the peripheral surface of the frame body so as not to be superposed on each other; or
the display panel and the drive circuit are both provided to one circuit board without being superposed on each other and are disposed along the peripheral surface of the frame body.

2. The wearable electronic device according to claim 1, wherein
the drive circuit and a plurality of electric circuits that include at least a power source are disposed on the circuit board to which the drive circuit is provided, so as not to be superposed on each other.

3. The wearable electronic device according to claim 1 or 2, wherein the display panel and the circuit board to which the display panel is provided are both flexible.

4. A method for manufacturing a portable device comprising a frame body that has a ring shape or a substantial C-shaped in cross section, and is mounted on the body of a user;
a strip-shaped display panel disposed along the peripheral surface of the frame body; and
a drive circuit for driving the display panel; wherein
the frame body is configured from a first frame body having a convex front-surface shape curved in a specific direction, and a second case body having a concave back-surface shape curved in the same specific direction;
the display panel and the drive circuit are provided to mutually different circuit boards, and the circuit boards are disposed along the peripheral surface of the second case body so as not to be superposed on each other, or the display panel and the drive circuit are both provided to one circuit board without being superposed on each other and are disposed along the peripheral surface of the second case body; and
the front surface of the first case body and the back surface of the second case body are superposed and mounted so as to be either directly or indirectly bonded together in an orientation in which there is a match between the directions of curvature thereof.

5. A method for manufacturing a portable device in which a first case body having a convex front-surface shape curved in a specific direction, and a second case body having a concave back-surface shape curved in the same specific direction are mounted and superposed so that the front surface of the first case body and the back surface of the second case body are either directly or indirectly bonded together in an orientation in which there is a match between the directions of curvature thereof, wherein
the first case body is elastic in the direction of curvature; and
at least part of the front surface of the first case body is directly or indirectly brought into contact with the back surface of the second case body in a state in which the first case body is deformed so that the radius of curvature of the shape of the front-surface shape is increased, and the first case body and the second case body are then superposed and mounted by releasing the deformation stress on the first case body.

6. The method for manufacturing a portable device according to claim 5, wherein the first case body is configured from a single member made of a uniform material.

7. The method for manufacturing a portable device according to claim 5, wherein stress is applied between the two ends of the first case body to deform the first case body.

8. A method for manufacturing a portable device in which a first case body having a convex front-surface shape curved in a specific direction, and a second case body having a concave back-surface shape curved in the same specific direction are superposed and mounted so that the front surface of the first case body and the back surface of the second case body are either directly or indirectly bonded together in an orientation in which there is a match between the directions of curvature thereof, wherein
the second case body is elastic in the direction of curvature; and
at least part of the front surface of the first case body is directly or indirectly brought into contact with the back surface of the second case body in a state in which the second case body is deformed so that the radius of curvature of shape of the front surface is reduced, and the first case body and the second case body are then superposed and mounted by releasing the deformation stress on the second case body.

9. The method for manufacturing a portable device according to claim 8, wherein the second case body is provided with a structure having a flexible window member.

10. The method for manufacturing a portable device according to claim 9, wherein the second case body is configured from a single member made of a uniform material.

11. The method for manufacturing a portable device according to claim 9, wherein the window member is configured separately from the second case body, and the window member is attached to the second case body after the second case body is mounted on the first case body.

12. The method for manufacturing a portable device according to claim 8, wherein stress is applied between the two ends of the second case body to deform the second case body.

13. The method for manufacturing a portable device according to claim 5, wherein the first case body and the second case body are superposed and mounted via a packing in a state in which the packing is mounted on either one of the first case body or the second case body.

14. The method for manufacturing a portable device according to claim 5, wherein the front surface of the first case body is superposed and mounted on the second case body so as to be in contact with the packing in a state in which the packing is mounted on the back surface of the second case body.

15. The method for manufacturing a portable device according to claim 5, wherein the first case body and the second case body are superposed and mounted with an internal module disposed between the first case body and the second case body, and the internal module is housed between the first case body and the second case body.

16. The method for manufacturing a portable device according to claim 15, wherein the internal module is flexible and capable of being curved in said specific direction.

17. A portable device wherein a first case body having a convex front-surface shape curved in a specific direction, and a second case body having a concave back-surface shape curved in the same specific direction are superposed and mounted so that the front surface of the first case body and the back surface of the second case body are either directly or indirectly bonded together in an orientation in which there is a match between the directions of curvature thereof;
at least one case body selected from the first case body and the second case body is elastic in the direction of curvature; and
stress is applied by the elasticity of at least one of the case bodies in the direction in which the front surface of the first case body and the back surface of the second case body are bonded together.

18. The portable device according to claim 17, wherein the first case body and the second case body are mounted via a packing.
